(19) United States
(12) Patent Application Publication
(10) Pub. No.: US 2023/0206195 A1
(43) Pub. Date: Jun. 29, 2023

(54) SYSTEMS AND METHODS FOR CIRCUMSTANTIAL AUTO-PAUSING OF RECURRENT TRANSACTIONS

(71) Applicant: Capital One Services, LLC, McLean, VA (US)

(72) Inventors: Abdelkader BENKREIRA, Washington, DC (US); Tyler MAIMAN, Melville, NY (US); Brendan WAY, Brooklyn, NY (US)

(21) Appl. No.: 17/564,039

(22) Filed: Dec. 28, 2021

(51) Int. Cl. G06Q 20/10; G06Q 20/40; G06Q 20/22

(52) U.S. Cl. CPC G06Q 20/102; G06Q 20/405; G06Q 20/407; G06Q 20/227

(57) ABSTRACT

Systems and methods for implementing an auto-pause functionality for recurring payment transactions that continue to be charged, despite being associated with an unavailable merchant service as mandated by a public closure restriction. One operational aspect of the disclosed systems and methods is active detection of a possible closure condition based on monitoring a ratio of on-line (Card Not Present) to in-person (Card Present) transactions, internally computed over several time windows. The outcome of the ratio test falling below a predefined value is indicative of a possible public closure condition. There is an external verification step based on externally provided information associated with a published closure notification. Disclosed process further involves an indexing operation for parsing and tracking of recurring transaction string data to facilitate the identification of invalid recurring transaction strings, once a public closure condition is verified.

### FIELD OF THE DISCLOSURE

The present disclosure relates to systems and methods for automated verification of electronic transactions, and more specifically to systems and methods for circumstance-triggered validation of recurring payment transactions.

### BACKGROUND

Certain external circumstances may impact the transactional activity of individuals/users on a public scale. One particular circumstance with a direct impact to commerce and commercial activities of the public is the developing situation regarding COVID-19-related public lockdown regulations. One particular area of impact, with respect to automation of electronic payment processing, is the unverified and/or automatic processing of recurring merchant charges (e.g., a recurring service or a membership charge) associated with merchant services temporarily interrupted by a public lockdown order/regulation. Such automated payment requests may be considered as invalid for the duration of a time period set forth, for example, by a lockdown notice. As such, transacting merchants associated with such recurring charges would normally be required to cease a particular recurring payment charge during periods of lockdown-related service interruptions. However, many such recurring charges, from merchants impacted by a closure scenario/condition and subject to lockdown-related service interruptions, continue to be automatically applied to various affiliated user accounts. This condition may continue unabated, until a user becomes aware of the recurring charge for an interrupted service and takes appropriate action to remedy the situation. A user may decide to either directly report the matter to the transacting merchant and request a cessation and/or refund of the recurring charges associated with an interrupted service. The user may also decide to take action through their financial institution to drop/halt certain invalid recurring merchant charges. Invalid recurring merchant charges may correspond, for example, to incoming recurring payment requests for a merchant service that has been interrupted or temporarily ceased due to a lockdown circumstance. Accordingly, systems and methods are required for an automated implementation of a smart verification process, operationally customized to address the aforementioned scenario that has emerged due to the recent development around the COVID-19 pandemic and the resulting public lockdowns and commercial service interruptions.

### SUMMARY OF THE DISCLOSURE

Embodiments of the present disclosure provide a method for implementing an intelligent automatic-pause functionality for recurring electronic transactions, the method comprising: monitoring electronic transaction activity associated with one or more financial accounts of a user, the electronic transaction activity corresponding to a plurality of electronic transactions comprising one or more cards not present (CNP) and one or more cards present (CP) transactions. The method further comprises performing a ratio test on the plurality of electronic transactions, the ratio test comprising computing a ratio of CNP to CP transactions over a predefined time window, and monitoring the computed ratio relative to a threshold value, by repeating the ratio test over a plurality of time windows, wherein a deviation in a value of the computed ratio, consistent with an increase in a relative number of CNP transactions, in excess of the threshold value, indicates a possible (mandated) closure scenario. Upon detecting the possible closure scenario, the method proceeds to initiating a verification of the ratio test based on identifying a corresponding published closure bulletin. The process of verifying the ratio test outcome (when it signifies a possible closure scenario/condition), amounts to confirming the existence of a closure condition and/or lockdown based a processing/analysis of externally-acquired information, such as a published text of a closure bulletin and/or a lockdown order. As such, the verification of the ratio test outcome may further comprise: extracting one or more data values for a first set of characteristic data parameters associated with the corresponding published closure bulletin and/or lockdown order, and storing the one or more data values corresponding to the first set of data parameters as a first data object in the data store. Upon verifying the ratio test, the method calls for initiating an identification of one or more invalid transaction strings corresponding to one or more recurring transaction requests from merchants impacted by the corresponding published closure bulletin. The identification of the invalid transaction strings comprise: extracting, from one or more recurring transaction strings, one or more data values corresponding to a second set of data parameter, storing the one or more data values as a second data object in the data store, wherein the second data object is associated with a uniquely-generated transaction identifier for indexing a respective recurring transaction request, and identifying a recurring transaction string as associated with an invalid transaction request based on a match between the first data object and the second data object. Once one or more invalid transaction strings, corresponding to a recurring payment charge for an interrupted merchant service, have been identified, a routine for executing one or more actions for each of one or more invalid recurring transaction strings is executed by the method.

According to some embodiments, the first set of characteristics data parameters for characterizing a commerce-impacting lockdown condition, comprise one or more of impacted geographical regions, the impacted merchant categories, and a projected timeline associated with the (mandated) lockdown condition. The characteristic data parameters may be extracted from a data repository of ongoing public closure and/or lockdown scenarios. The data may also be scraped/requested from one more official city/state/federal website, and/or obtained from electronic notifications transmitted by relevant authorities. In effect, the first set of characteristic data to characterize the lockdown scenario in terms of relevant parameters such as impacted areas, affected merchants/merchant services and a projected time period, may be acquired from any trusted information source using one or more data extraction routines. The proposed method further comprises computation of a second set of data parameters (related to the electronic transaction data) corresponding, for example, to a merchant service location where the transaction was conducted and a merchant type/category. The second set of data parameters may be extracted from incoming recurring transaction strings corresponding to one or more financial accounts associated with a user.

In some exemplary embodiments, the computation of the second set of data parameters (e.g., extraction of relevant electronic transaction data from incoming transaction strings) may be triggered by the verification of a possible closure condition. The computation of the second set of data parameters may also occur independently of the operations involved in the detection and verification of a public closure or lockdown condition. In some embodiments, the processes for extraction and storing of relevant transaction-related information (e.g., merchant name/type and location) from one or more recurring transaction requests may occur concurrently with the operations involved in detection and verification of a public closure/lockdown condition.

Embodiments of the present disclosure provide an automated system and method for adapting the electronic processing of recurring payment transactions, responsive to external circumstances that may impact the transactional activity of a user. In accordance to some embodiments, this is accomplished by the implementation of a circumstantially-activated auto-pause (i.e., automatic-pause) functionality in processing of recurring payment transactions.

Some aspects of the present disclosure are directed to a system for management of recurring electronic transactions with a verification process that is equipped with a circumstantial auto-pause (i.e., automatic-pause) functionality for transaction requests that have been deemed as circumstantially invalid. One example of a circumstantially invalid transaction request, subject to the auto-pause action, involves a recurring transaction request generated by a merchant financial system for a service that has been interrupted by a mandated public lockdown order. The proposed system may comprise a computer hardware arrangement configured to monitor electronic transaction activity associated with one or more financial accounts of a user, the electronic transaction activity corresponding to a plurality of electronic transactions comprising one or more card not present (CNP) and one or more card present (CP) transactions. The system may be further configured to perform a ratio test on the plurality of electronic transactions, the ratio test comprising computing a ratio of CNP to CP transactions over a predefined time window. The ratio test may be conducted concurrently with monitoring of electronic transaction activity which may also involve the extraction and indexing of relevant information from the incoming transaction strings associated with various recurring transaction requests. The system then monitors the computed ratio relative to a threshold value, by repeating the ratio test over a plurality of time windows, wherein a deviation in a value of the computed ratio, consistent with an increase in a relative number of CNP transactions, in excess of the threshold value, indicates a possible closure scenario. Upon detecting a possible lockdown scenario based on the ratio test, the system will verify the detected (possible) lockdown scenario (i.e., the outcome of the ratio test) by identifying a corresponding published closure bulletin and extracting relevant information associated with the corresponding mandated closure order (i.e., impacted regions and merchants.) The relevant closure-related information may also be provided by a third-party data service. The system may be further configured to store the relevant closure-related information for comparison against relevant data elements extracted from respective transaction strings, in order to identify one or more invalid transaction strings by correlating the relevant transaction data elements with information regarding impacted regions and merchant services, that may have been obtained from a published closure bulletin. In some embodiments, information associated with a recurring transaction string may be associated with a uniquely-generated transaction identifier in order to index a respective recurring transaction request. The system may flag transaction index identifiers associated with recurring transaction requests that have been identified as invalid. In this way incoming invalid transaction strings associated with a flagged transaction index identifier may be immediately identified and acted upon without a need to repeat the data extraction and comparison operations. If an incoming recurring transaction string is identified as being associated with a flagged identifier in a data store (i.e., the transaction string is associated with the recurring transaction request that was previously identified, indexed and flagged) it may be immediately identified as an invalid transaction string and acted upon appropriately. If an incoming recurring transaction string is not associated with an existing identifier in the data store (i.e., it is a new or a previously un-indexed recurring transaction), the relevant data is extracted from the incoming new transaction string. The extracted data is stored, indexed and subsequently compared with information regarding lockdown-impacted merchant services and service locations to determine the validity of the incoming new recurring transaction. If a match is determined, the corresponding uniquely-generated identifier may be flagged and acted upon in accordance to system configurations.

### BRIEF DESCRIPTION OF THE DRAWINGS

Various embodiments of the present disclosure, together with further objects and advantages, may best be understood by reference to the following description taken in conjunction with the accompanying drawings.

FIG. 1 depicts a two-server implementation of a circumstantial automatic-pause functionality with concurrent transaction indexing, in accordance to some embodiments of the present disclosure.

FIG. 2 depicts a two-server implementation of a circumstantial automatic-pause functionality with triggered transaction indexing, in accordance to some embodiments of the present disclosure.

FIG. 3 depicts a one server implementation of a circumstantial automatic-pause functionality, with an integrated data store and a lockdown verification feature based on external information, in accordance to some embodiments of the present disclosure.

FIG. 4 illustrates an operational flow diagram for a circumstantial automatic-pause process, according to some embodiments of the present disclosure.

FIG. 5 depicts a one server implementation of circumstantial automatic-pause functionality with an (externally verified) internal closure detection feature, in accordance to some embodiments of the present disclosure.

FIG. 6A depicts an operational flow diagram for identification of circumstantially-invalid recurring transaction strings based on a concurrent transaction indexing process, in accordance with some embodiments of the present disclosure.

FIG. 6B depicts an operational flow diagram for identification of circumstantially-invalid recurring transaction strings based on a triggered transaction indexing process, in accordance with some embodiments of the present disclosure.

FIG. 7 depicts a process for identification of circumstantially-invalid transactions based on concurrently-running circumstance detection and indexing processes, in accordance to some embodiments of the present disclosure.

FIG. 8 is an illustration of an exemplary block diagram of an exemplary system in accordance with certain exemplary embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

One feature of electronic commerce that has been directly impacted by the recent Covid-19 pandemic and the resulting mandated restrictions on physical public presence is the processing of recurring payment transactions associated, for example, with merchants offering recreational and/or educational services delivered to the public at a facility. In accordance to some embodiments, a verification operation may be implemented for recurring transaction, based on, for example, externally-provided information regarding a published lockdown regulation and/or a mandated order restricting merchant services. In some embodiments, the verification operation may be triggered by an internal detection process that identifies a possible lockdown scenario based on a detection of a deviation (in excess of a predefined threshold) in the transactional activity pattern of a user.

One embodiment of the proposed system and method may involve the retrieval of various regulatory guidelines and notifications associated with various city/state/federal mandated regulations (e.g., public lockdown) that may impact the provision of certain recurring merchant services (e.g., health clubs). This information may be internally modelled/predicted by the proposed system and method, and/or externally obtained from one or more data repositories, using, for example, one or more Application Programming Interface (API) calls.

As discussed above, the exemplary system, method and computer-accessible medium can utilize and incorporate machine learning processes to aid in the internal modelling/predictions of an external circumstance such as a public lockdown scenario that may be reflected by specific changes in the user's transactional pattern. The incorporated machine learning processes may utilize information from various mobile applications (i.e., GPS data) running on a user's device, to aid in the computations involving (internal) detection of an external occurring circumstance such as a public closure condition and/or a lockdown order. In order to produce a more accurate predication, based on detection of tell-tale deviations in a user's transactional and/or electronically-recorded activity patterns, various exemplary models can be generated, for example, for modelling average daily/weekly walking/driving times, average time between in-person and/or on-line purchase transactions, as well as other electronically-recorded activities. The exemplary system, method and computer-accessible medium can then apply the generated models for various user-related activity parameters to current evaluation of a user's activity profile to identify an existing external condition or circumstance.

In some embodiments, this information may be provided by a third-party provider. The information may be provided by a third party in an encoded form that can be received and directly processed by a computing device. The information may also be encoded internally by the proposed process/system. The encoded information may then be parsed and processed to extract from it, the relevant data values. These data values can then be ingested, in conjunction with the extracted and processed transaction data elements, by one or more logical operations to identify invalid recurring transaction strings. In accordance to some embodiments, the aforementioned functionality is integrated as part of a system/process to implement an intelligent auto-pause feature/functionality relevant to systems/methods for management of electronic payment transactions.

The proposed solution may be deployed, for example, as an additional verification step in the processing of electronic payment transactions. In accordance to some embodiments of the present disclosure, the additional verification step is circumstantially triggered and applicable to recurring payment transactions. The integration of a circumstantially triggered verification process results in an improved method of processing recurrent payment transactions that is dynamically responsive to sudden service interruptions that may result from one or more public lockdown orders. In accordance to some embodiments, recurring payment transactions refer to automated card not present (CNP) payment transactions wherein a financial charge is applied on a cyclic basis, such as a monthly membership fee.

In some embodiments, detection of a target circumstance such as a public lockdown may be achieved by retrieval and processing of relevant information from published regulatory guidelines and closure notifications to extract one or more data values corresponding to the merchant types and geographical areas impacted by a public closure order. According to some embodiments, the extracted data values may be stored as one or more data objects in a data store. A data store may comprise a storage medium where extracted information regarding various social distancing and public lockdown regulations may be logged.

As described, in accordance to some embodiments, the extracted lockdown-related information may be stored as one or more data objects with data values identifying one or more geographical locations (corresponding to data elements such as zip codes, or city and state identifiers) and merchant types/services (corresponding, for example, to merchant category codes (MCC)). In some embodiments, additional information provided regarding a mandated lockdown/closure order, may be used to further narrow down the impacted geographical region to a district or one or more city blocks based, for example, on one or more street addresses.

According to some embodiments, an API call is transmitted to a data repository for retrieving the most updated information regarding, for example, an effective duration of a lockdown order and/or a rollback date. In some variations, a notification may be sent to the user and the transacting merchant, to inform both the involved parties of the status of a recurring payment transaction.

Some embodiments of the present disclosure, may involve continuous and/or periodic polling of a third-party database and/or a subscription to a messaging service from a third-party data provider for timely identification and status tracking of a pubic lockdown condition prior to initiating the circumstantial verification process. Some embodiments incorporate an internal detection mechanism/routine based on internal processing/analysis of the electronic transactional activity to identify above-threshold deviations in the transactional activity pattern, indicative of a possible public closure scenario.

According to some embodiments, a deviation in a transaction activity pattern, identified as being indicative of a possible lockdown scenario, may be further verified against one or more external sources. For example, an indication of a possible lockdown condition, derived based on an analysis of incoming and/or stored transaction records (i.e., detection of anomalous transactional activity), may be corroborated against stop-payments request/reports received from one or more users. This verification may be based on, for example, a keyword search of the reported stop payments request based on regulatory grounds. Some variations may involve a more intelligent keyword search incorporating a degree of data processing and analytics routines. In some embodiments, a process of parsing/processing the transaction strings for identifying circumstantially invalid transactions may also involve one or more operations for compiling a listing of particular keywords and text strings generally used in stop-payment requests that may be indicative of a mandated lockdown regulation.

According to some embodiments, a transactional pattern processing approach associated with the ratio test may be supplemented in different ways, such as by performing correlations with recorded transaction stop requests, for accurate detection of recurring payment transactions that have not been paused/suspended during a time period mandated by a public closure order.

According to some embodiments, changes in patterns may be detected over a predetermined time window. Computation of one or more transactional activity patterns/parameters over one time window can then be compared with computed parameter values for a subsequent time window in order to identify developing patterns in the transactional activity that may be indicative of, for example, a public closure order being in effect. In some embodiments, a continuous monitoring of relevant parameters may be implemented by repeating the computation over several time windows. In some embodiments, the computed transactional activity pattern/parameters correspond to a computation and monitoring of the ratio of online or card not present (CNP) transactions to in-person or card present (CP) transactions. In some embodiments, an increase in a relative number of CNP transactions, in excess of a predetermined threshold value, may indicate a possible closure scenario/circumstance. The threshold value may also be dynamically determined/computed, in accordance to some embodiments of the present disclosure.

According to some embodiments, one or more data analytics and machine learning routines may be applied to supplement the computation of transactional activity patterns/parameters to improve the accuracy of correctly predicting a public closure scenario, based on detection of relevant patterns in the transactional and other electronically-recorded user activities that may be indicative of a public closure scenario. This may be supplemented by a use of various prediction models such as ones that can utilize Bidirectional Encoder Representations from Transformers (BERT) models. BERT models utilize multiple layers of so-called “attention mechanisms” to process textual data and make predictions. These attention mechanisms effectively allow the BERT model to learn and assign more importance to words from the text input that are more important in making whatever inference is trying to be made.

The exemplary system, method and computer-accessible medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections and can have tied weights followed by some form of pooling, which can result in translation invariant features.

An RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. An RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly-feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory and can be part of long short-term memory networks (“LSTMs”) and gated recurrent units.

RNNs can be similar to a network of neuron-like nodes organized into successive “layers,” each node in a given layer being connected with a directed (e.g., one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNN's performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously collected data, such as data collected from previous uses of the same type of systems described herein and data collected from different types of systems. This, for example, may apply to user transactional activity analyzed in conjunction, for example, with navigation data from a user mobile device. In other examples, the training datasets may comprise continuously-collected data based on the current operation of the instant system and continuously-collected data from the operation of other systems (i.e., real-time tracking of electronic transaction data and the data from a user's GPS application). In some examples, the training dataset may include anticipated data, such as the anticipated future travel pattern and purchasing action pattern, currently scheduled workloads, and planned future workloads, for the instant system and/or other systems. In other examples, the training datasets can include previous predictions for the instant system, and other types of system, and may further include results data indicative of the accuracy of the previous predictions. In accordance with these examples, the predictive models described herein may be training prior to use and the training may continue with updated data sets that reflect additional information.

According to some embodiments, a shutdown scenario may be externally verified prior to initiating an indexing process for transaction strings as part of a process to identify recurring transactions associated with merchants falling under a shutdown jurisdiction that have not halted the recurring payments process. Some embodiments may involve a back-end process that may be put into place for identifying merchants with recurring payment transactions, in a geographical region, subject to a shutdown regulation. For example, a back-end processor may be configured to identify recurring transactions associated with merchants within a regulated area. There may be some merchants with multiple service locations that may all be associated with the same merchant/brand names and payment network. For such merchant transactions, a transaction string may not distinctly identify a specific location based on, for example, a street address. Accordingly, some embodiments of the present disclosure utilize a combination of data values such as a merchant ID along with any available location-related data, to approximate the street address and identify the relevant merchant. In accordance to an exemplary workflow a backend processor may be configured to identify recurring transactions associated with impacted/interrupted merchant services. Once a merchant is detected, additional logic checks may be put into place to execute one or more actions which may comprise issuance of an automatic decline and/or sending of one or more notifications to an associated user device to request a user confirmation of a particular auto-pause action prior to its invocation.

In accordance to some embodiments, a recurring transaction may be characterized by a set of data parameters corresponding to a merchant service location and merchant type information associated with a recurring transaction request. The aforementioned set of data parameters may be extracted from one or more transaction string instances associated with the recurring transaction request.

According to one embodiment, the parsing and indexing of recurring transaction data may be executed concurrently with the computing and monitoring of a possible closure condition (i.e., the ratio test). In accordance to another embodiment, the parsing and indexing of recurring transaction data may be triggered once a detected possible closure condition is verified. The former being more resource-intensive, but faster, than the latter.

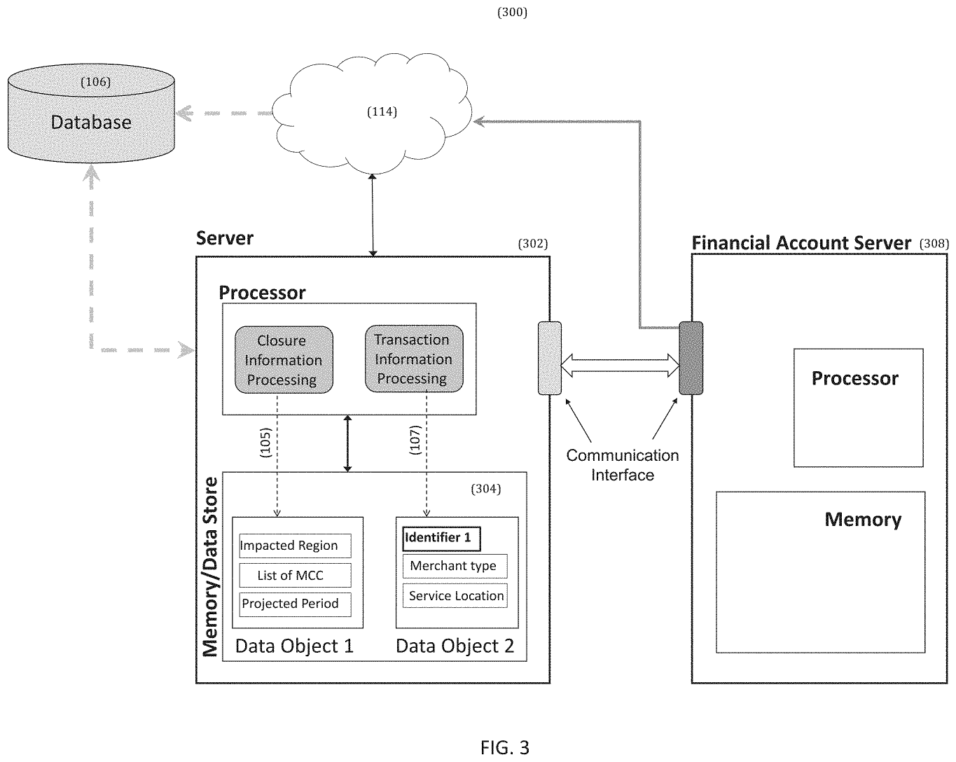

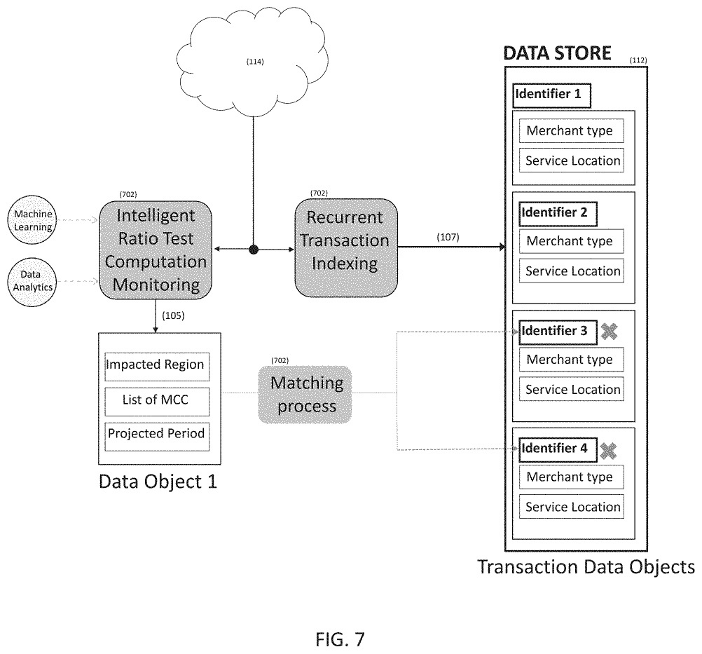

In some embodiments, the indexing of recurring transaction requests comprising of extracting and storing, together with a unique identifier, and one or more transaction data values, occurs independently of computing and monitoring of the ratio test. Other embodiments may involve identifying one or more incoming transaction string as being associated with an indexed recurring transaction request, if the one or more incoming transaction strings are identified as having a corresponding unique identifier in the data store, wherein the extracting and storing of one or more transaction data, does not pertain to the one or more incoming transaction strings for which a corresponding unique identifier exists in the data store. FIGS. 3 and 7 further illustrate an example of storing extracted circumstance-related (i.e., public lockdown scenario) and recurring transaction-related information as respective data objects. FIGS. 3 and 7 also illustrate an example of indexing and flagging of data objects associated with recurring transaction data that match characteristic data parameters associated with a lockdown condition (i.e., one or more impacted geographical regions, one or more impacted merchant categories, and a projected timeline associated with the mandated closure scenario). Some embodiments may, for example, involve flagging a unique identifier, associated with an invalid transaction request, in the data store, and identifying one or more incoming transaction strings as invalid if a flagged unique identifier, corresponding to the incoming transaction string, is located in the data store.

According to some embodiments, a recurring transaction may be associated with a virtual credit card number (VN). Since a VN is associated with a bound merchant, a toggle mechanism may be used to simply turn a specific VN on/off based on a developing lockdown scenario. As such, in some embodiments of the present disclosure, a VN, provided by a corresponding transaction string, may be used as a transaction identifier index. For example, in cases where a recurring transaction corresponds to a VN transaction, the unique transaction identifier for indexing a recurring transaction data object (linked to relevant transaction data values) may correspond to the virtual credit card number associated with the recurring transaction request. In such cases, as described above, a toggle feature on a decline logic associated with the VN may be used to control the recurring transaction request.

According to an embodiment, a unique VN may be generated and bound to a merchant associated with a recurring transaction request, even if the recurring transaction request does not correspond to a VN transaction string. Therefore, a VN may be used as a unique identifier for indexing and controlling recurring transaction requests that are not initially associated with a VN transaction string. In such cases, connecting a recurring transaction to a VN may provide added control functionality and operational advantages, as well as reducing a likelihood of fraud since the actual credit card number will not be exposed. Accordingly, the toggle operation on a decline logic associated with the VN can be used to control a recurring transaction, even if the transaction is not initially a VN transaction. According to this embodiment, a decline operation executed on a VN will then apply to all transactions associated with the VN-bound merchant.

According to some embodiments, in response to detection of an invalid recurring transaction (i.e., transaction corresponding to location of shutdown and merchant type) one or more actions may be automated. The one or more actions may comprise declining the transaction with a reason code that is transmitted back to the merchant. In some embodiments, declining the transaction may be preceded by transmitting a notification message to a mobile device associated with the user and requesting a user confirmation prior to declining the transaction. The one or more actions may also comprise generation of an automatic-pause operation applied to the invalidated recurrent merchant transaction.

In some embodiments, the circumstantial automatic-pause functionality may require enrollment by the user. In some embodiments, the service may be provided automatically to users without requiring service enrollment by the user. According to some embodiments, a mechanism for re-starting a recurring payment, upon termination of a shutdown period, may involve tracking the data values for a first set of data parameters associated with a shutdown/lockdown order (i.e., a public closure bulletin) wherein the first set of data parameters correspond to an impacted geographical region, merchant categories and a projected timeline associated with the closure notification. The first set of data parameters may be stored as a data object(s) that may be updated periodically based on latest information provided by an appropriate data repository or a third-party service provider. In some embodiments, this information may be scraped directly from one or more relevant databases, for example, by using one or more API calls. The information may then be used to update data parameter values in the corresponding data object. Some embodiments may involve API calls to a corresponding database for the latest information on a closure/lockdown circumstance, prior to initiating the extraction and indexing of recurring transaction data.

In some embodiments, the resumption of a recurring payment may be based on the computed ratio (as associated with the ratio test) dropping below a threshold value. The resuming of a recurring payment may further comprise transmitting a notification to the user prior to allowing a recurring transaction request, wherein the allowing of the transaction is contingent upon an affirmative response from the user with regards to the resumption of recurring payments.

Some aspects of the present disclosure are directed to systems and methods for automated identification/prevention and/or flagging of recurring electronic payment charges that have not been paused/suspended during a time period mandated by a public closure order, which is particularly relevant to the current landscape. As such, some embodiments describe a specific implementation for a circumstance-triggered transaction verification functionality based on i) detecting/verifying the specific circumstance (based on one or more internal and external operations), ii) identifying recurring transactions impacted by the circumstance (i.e., merchant service interruption due to a public lockdown order) and automating one or more actions with respect to the impacted transactions.

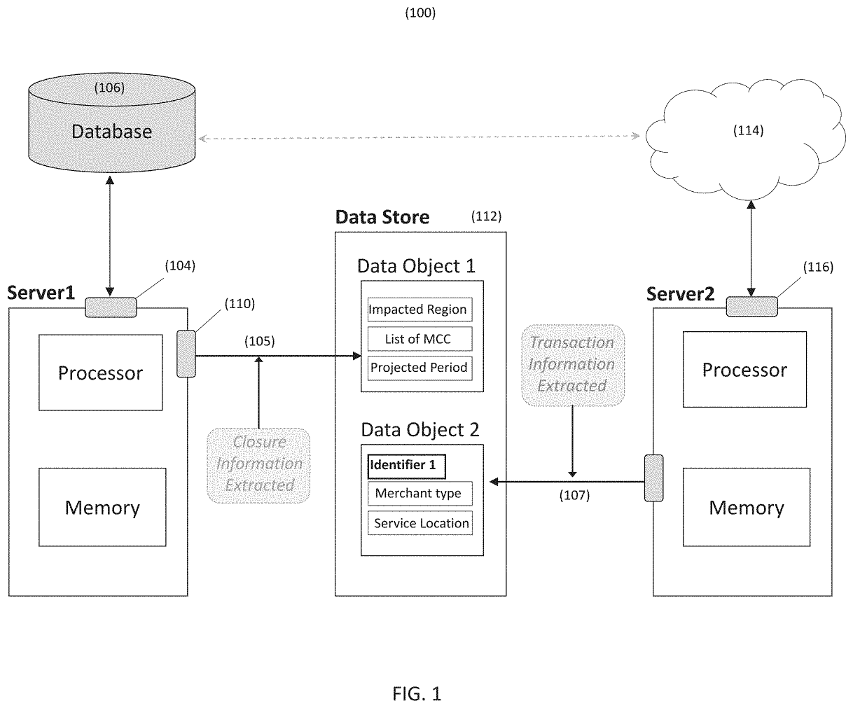

FIG. 1 illustrates an exemplary two-server implementation of a circumstance-triggered verification system (100) for recurring transactions, in accordance to an embodiment of the present disclosure. According to the embodiment depicted in FIG. 1, Server 1, comprising a processor and memory, may be configured for the detection and monitoring of an external condition/circumstance impacting commerce and a user's transactional activity pattern and behavior. Server 1 may be communicatively coupled, via a communication interface 104, to a Database 106. Database 106 may correspond to a data repository for storing relevant public lockdown information. Database 106 may be administered by a third-party data provider and/or maintained by one or more municipal/state/federal government agencies. The information obtained from Database 106 may be processed by Server 1 for extraction of relevant data values regarding impacted merchant services and geographical regions. This information, along with relevant transactional data (i.e., data elements extracted from one or more transaction strings associated with a recurring transaction request), may then be utilized for identifying one or more (invalid) recurring transaction strings associated with lockdown-impacted merchant services. Server 1 may locally and/or externally store the aforementioned relevant data values in respective data objects. In the exemplary embodiment (100), the relevant circumstance-related data values are provided via a communication interface (110) on Server 1 to data store (112) and stored therein as Data Object 1, which comprises data values pertaining to impacted regions (identified for example by one or more parameters such as a zip code, state, city, district, etc.), listing of Merchant Category Codes (MCC) identifying impacted merchant types/services, and any provided information with regards to the projected period of the lockdown. The generation of relevant circumstance-related data parameter values and its storage as corresponding data objects is represented by (105) in the exemplary embodiment (100) shown in FIG. 1.

As described above, the lockdown related information, stored as Data Object 1 in FIG. 1, needs to be mapped onto relevant transactional data, in order to identify one or more recurring transaction strings associated with impacted merchant services (i.e., invalid recurring payment transaction requests). This information may be provided by a process running locally on Server 1 or by an external process. In the exemplary embodiment (100), this information is provided by Server 2. Server 2, comprising a processor and memory, may be configured for the collection of transaction information (i.e., transaction strings obtained from network 114, through a communication interface 116), as well as the processing of the collected transaction information for the extraction and indexing of relevant transaction data values associated with each distinct recurring transaction request. The generation of relevant transaction data values and its storage as a corresponding data object is represented by (107) in the example shown in FIG. 1.

Network (114) may correspond to one or more proprietary payment processing networks and/or a public network, such as the Internet, that may also be communicatively coupled to the Database 106 for providing closure/lockdown related information.

Referring back to FIG. 1, a unique identifier (i.e., identifier 1) is generated by Server 2 for indexing the extracted transaction information (i.e., a merchant type and a service location associated with a recurring payment transaction request). Identifier 1 is then stored along with the extracted transaction information in a corresponding data object (i.e., Data Object 2 in FIG. 1). The corresponding identifier (i.e., identifier 1) for Data Object 2 may also be stored, within data store (112), as an independently searchable index pointing to Data Object 2.

As described above, the process associated with creation of Data Object 1 and Data Object 2 may occur concurrently or at different relative times. For example, the embodiment (100) illustrates a concurrent approach whereby the creation of Data Object 2 (representing Data Objects dedicated to storage of recurring transaction information, such that each data object represents information associated with a distinct recurring transaction) is independent of the creation of Data Object 1. Accordingly Data Object 1 and 2 may be created dynamically and stored, for example, in an externally implemented data store (112) which may be shared by Server 1 and Server 2.

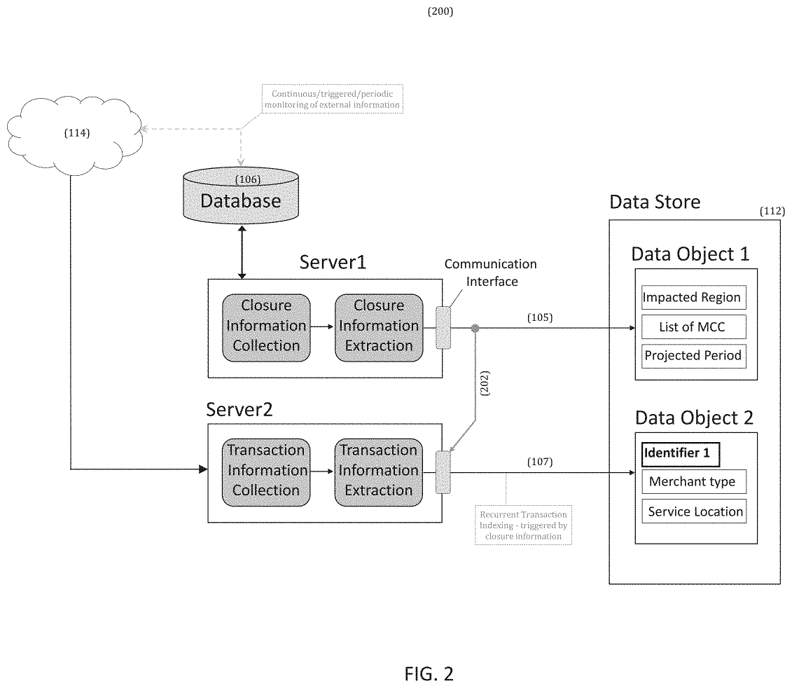

In accordance to an exemplary embodiment (200) illustrated in FIG. 2, the detection of a target circumstance, in this case a public lockdown order, may trigger the transaction information processing for extraction and indexing of relevant data for each distinct recurring transaction request. In accordance to the embodiment (200), a first process for collection of a public closure lockdown related information and extraction of relevant data value therefrom may be carried out by one or more processes running on Server 1 (with the extracted value stored as a data object, namely Data Object 1.) The completion of the first process by Server 1 may then initiate (i.e., as depicted by the operation flow indicator 202) a second process for the collection/extraction and indexing of relevant recurring transaction data processes. The second process may be running on the same server/device (i.e. Server 1) or it may be carried out by a different server/device (i.e., Server 2).

Referring back to FIG. 2, exemplary embodiment (200) may involve continuous or periodic monitoring of closure related information using a third-party data service (i.e., Database 106). In the illustrated embodiment (200), the operations involving collection and indexing of recurring transaction information as performed, for example, by Server 2, may be triggered after the identification of a target external scenario (i.e., public lockdown scenario) as performed, for example, by Server 1. The output of the aforementioned operations, as well as being stored as a corresponding data object in the data store, may also be used to trigger the transaction information collection and indexing process conducted, for example, on Server 2. This relationship is represented by the operation flow indicator (202) in the exemplary embodiment (200). As described, in accordance to some embodiments of the present disclosure, the information regarding a public closure condition may be reported to Server 1 by a third-party data service provider administering Database 106. According to some embodiments, the relevant information may be actively monitored by one or more API calls generated by one or more processes running, for example, on Server 1. The aforementioned triggered approach may be less resource intensive as the transactional information extraction and indexing operations are initiated upon detection of the public closure condition. While, the concurrent approach may be more responsive and faster as the relevant recurring transaction information is ready for comparison upon detection of the target external circumstance/condition (i.e., the public closure condition.)

FIG. 3 illustrates a one server implementation of a circumstantial auto-pause functionality, in accordance to some embodiments of the present disclosure. Server/device (302) may have one or more processes configured for collection and processing of information related to a public closure/lockdown. Server/device (302) may also have one or more processes configured for collection and processing/indexing of relevant information regarding one or more recurrent transaction requests. In the exemplary embodiment (300), data store functionality may be provided by the integrated server memory (304). Server 302 may be configured with a first process for collecting, monitoring, and processing of information associated with a target external circumstance and a second process for collecting, processing and data extraction of recurrent transaction strings. The first and the second process may be executed concurrently or at different relative times, as described above in accordance to some embodiments. The data store may also be implemented as an external drive or database as depicted, for example, in FIGS. 1, 2 and 5. The operations associated with the first and the second process may be executed on a different server than a server/device where a user's financial account information are stored as illustrated in the exemplary embodiment (300), wherein the identification of invalid recurring transaction requests, resulting from matching transaction-related information with relevant lockdown-related information, is communicated to a financial account server (308) for execution of one or more actions comprising authorizing or declining transaction requests made against the user account.

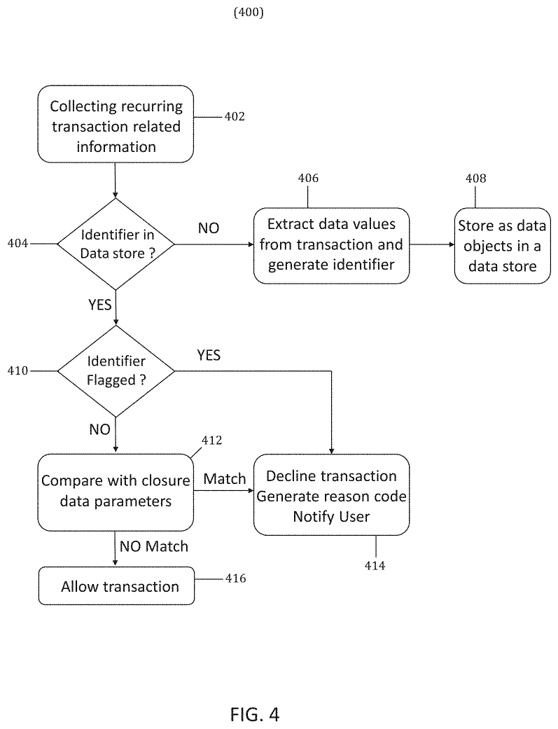

FIG. 4 illustrates an operational flow diagram (400) for a circumstantially triggered verification of incoming recurring transaction requests (based on identification of circumstantially invalid recurring transaction strings). Recurring transaction strings are processed, and relevant transaction data values are extracted and indexed with a unique identifier. A circumstance-related data object (i.e., Data Object 1) is then compared against indexed list of recurring transaction requests for a match. Upon detection of a match one or more actions may be executed. Such actions may comprise placement of an automated pause on an identified recurring transaction and/or a flagging of the identifier associated with the recurring transaction in the data store, wherein incoming transaction strings associated with a flagged recurring transaction may be subject to one or more specified actions such as declining the transaction and/or generation of relevant notification to the corresponding customer and/or merchant.

Referring back to FIG. 4, at (402) information regarding one or more recurring transactions is collected. Appropriate data store or memory module may then be checked to identify an existing identifier corresponding to the incoming transaction string (404). According to one embodiment, an identifier for a particular recurring transaction request may be generated based on common information that would be included in every transaction string associated with the particular recurring transaction request. If no existing identifier, for a particular recurring transaction string, is located in the data store, relevant transaction information is extracted and stored/indexed (i.e., using a generated identifier) in a data store, as shown by the process step (408). In accordance to some embodiments, a new identifier based on, for example, a corresponding VN, may be generated as an index for each distinct recurring transaction request.

If a corresponding identifier, for an incoming recurring transaction string, already exists in the data store, the identifier may be checked to see if it is flagged (410). If the identifier already exists in the data store/memory and it has been flagged, then it is associated with a circumstantially-invalid recurring transaction request, in which case one or more actions, (e.g., declining the transaction with a reason code sent back to the transacting merchant) may be carried with respect to the incoming transaction request, as shown by process step 414. If a transaction identifier, associated with the incoming transaction, is located in the data store/memory, but is not associated with a flag, then it corresponds to a valid recurring transaction string. As a verification step, another comparison test may be conducted against one or more externally obtained closure-related data parameters to promote the recurring transaction request being in compliance with latest available information regarding a developing external circumstance (i.e., public lockdown status). If a verification step (412) produces a match, the corresponding transaction identifier is flagged and the corresponding one or more actions, prescribed for dealing with invalid transaction requests, is carried out with respect to the incoming transaction request, as shown by process step 414. If the verification step produces no match, further processing of the payment transaction is allowed to proceed (416).

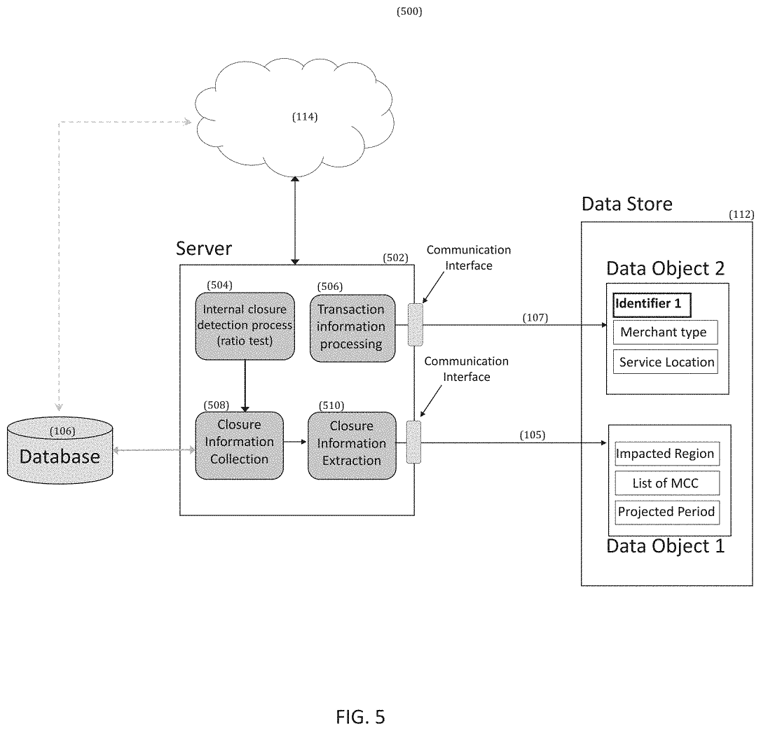

FIG. 5 illustrates an exemplary embodiment comprising an internal detection process that is based on conducting a ratio test, which involves a computation of a ratio of on-line or card not present (CNP) transactions to in-person or card present (CP) transactions. This operation is shown by process (504) running on Server 502. Transaction information processing and indexing operations (506) that may be running independently of process (504) may continue to identify and process incoming recurring transactions as one or more data objects (i.e., Data Object 2) which are stored as relevant transaction data values (such as the transacting merchant type and service location) which can be compared with corresponding circumstance-related information (i.e., impacted region and merchant categories associated with a public lockdown order.) The generation of relevant transaction data and its storage as corresponding data objects is represented by (107) in the example shown in Fig.5. Upon detection of a possible public closure/lockdown condition based on the result of the ratio test, a verification process of the possible lockdown condition (as determined by the ratio test) may be carried out based on externally provided information with respect to a closure mandate that has been put into effect. This is shown by the process (508). Once the target circumstance (i.e., a lockdown condition), has been verified, relevant data values may be extracted (510) and stored as a corresponding data object (i.e., Data Object 1) in the data store (112). The generation of relevant circumstance-related parameter values and its storage as corresponding data objects is represented by (105) in the example shown in Fig.5.

According to the exemplary embodiment (500), externally provided information from, for example Database (106), may be requested in order to verify an internally identified/detected possible closure scenario. Specific operations for processing and indexing of information associated with recurrent transactions may be concurrently ongoing or it may be initiated upon a detection and/or verification of a possible closure condition.

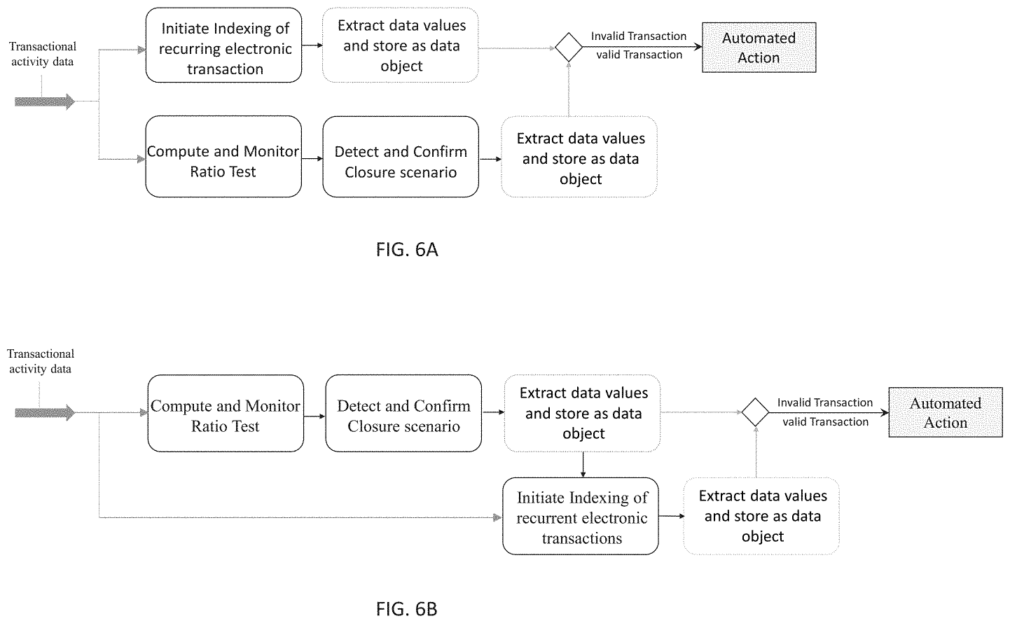

As described above, some exemplary embodiments of the disclosed technology may involve concurrently running circumstantial-detection and transaction data processing/indexing operations, while some embodiments may be directed to a process by which transaction data processing/indexing is triggered or initiated by the outcome of the circumstance-detection process. These embodiments are illustrated in FIGS. 6A and 6B respectively.

Illustrated in FIGS. 6A and 6B are two exemplary embodiments for implementing the circumstantial automatic-pause functionality and/or service. In the exemplary arrangement of FIG. 6A, incoming electronic transactions are monitored based on an internally running ratio test. An external verification step may then be conducted based on the monitored outcome of the internally conducted ratio test. In FIG. 6A, ratio test computation/monitoring process (i.e., monitoring of a ratio test computed across various time intervals) is conducted concurrently with the processing and indexing of recurring transaction information. In this way, invalid transaction strings may be identified as soon as a target circumstance or external condition is detected, thus leading to a more responsive and prompt execution of prescribed automated actions.

In FIG. 6B, transaction processing/indexing processing is triggered/initiated upon detection and verification of a target circumstance, such as a mandated public closure order. In the exemplary arrangement of FIG. 6A, incoming electronic transactions are monitored based on an internally running intelligent ratio test. When a computed outcome of the internally running intelligent ratio test breaches a predefined threshold value, an indication of a possible public closure scenario is generated. Upon obtaining a verification of the detected/identified possible closure scenario, the transaction indexing operation is initiated. In this exemplary arrangement, the indexing may be initiated, for example, at any point after a target condition/scenario is detected and verified. In some embodiments, the transaction data objects may be compared with scenario data objects in real time as each recurring transaction string is processed and indexed. For example, the matching process may be a continuously running process which compares scenario data values with relevant transaction information as the information becomes available. According to some embodiments, relevant recurring transaction data parameters are extracted and stored as distinct data objects, with each data object representing a distinct recurring transaction, and may be assigned a uniquely generated identifier. Subsequently incoming transaction requests associated with an indexed transaction are simply subject to previous actions.

FIG. 7 illustrates an exemplary embodiment of an automated circumstantial transaction verification process featuring an internally conducted intelligent ratio test (702) supplemented by one or more machine learning and/or data analytics routines. As shown in example (700), process (702) corresponding to an internal computation and monitoring of an intelligent ratio, may be conducted in parallel with one or more processes (704) for the collection/parsing and indexing of recurring transaction data, which are stored as one or more transaction data objects with a corresponding index identifier (i.e., an identifier associated with a recurring transaction data object stored in data store/memory). For example identifiers 1-4 are each associated with a data object that represent a distinct recurring transaction request based on, for example, transacting merchant type and service location. According to aforementioned embodiment, an external verification of the target circumstance (using, for example, a third-party data provider) may not be required based on an improved accuracy of the utilized internal model for detection of a target circumstance. An automated matching process (706) may be continuously/periodically looking for a match between data values extracted for a detected external condition and transaction data stored as one or more indexed data objects and flagging an identifier associated with a transaction data object associated with matching data values detected stored in respect to data parameters associated with a detected circumstance.

In some embodiments, the matching process (706) for identification of circumstantially invalid recurring transaction requests, may be triggered when there is a new circumstance data object to compare the relevant data values against transaction information stored and indexed in the Data store. In some embodiments, the matching process may be a continuously running process which compares scenario data values with relevant transaction information as the information is being extracted and stored as distinct data objects for each transaction associated with a recurring purchase request.

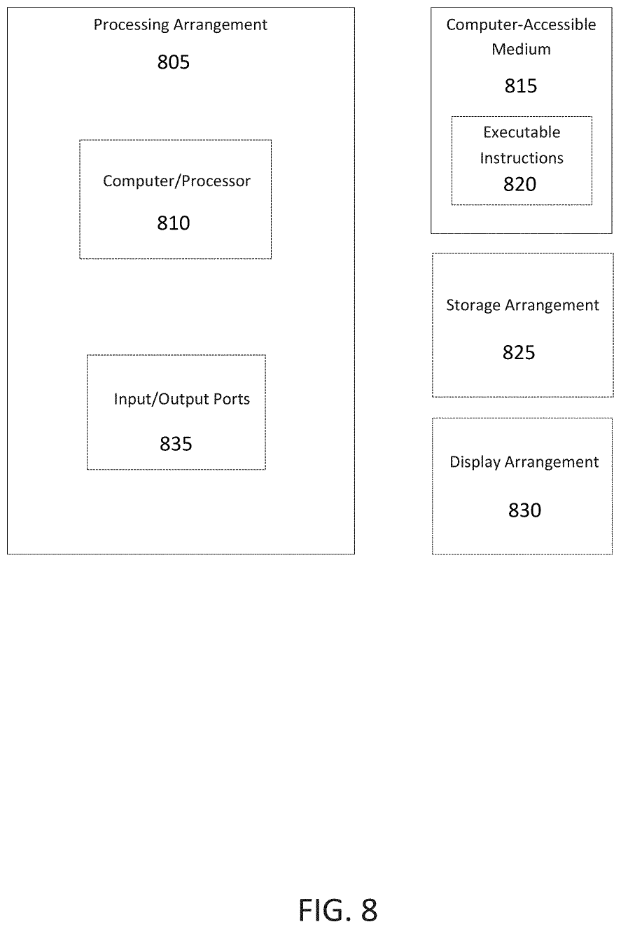

FIG. 8 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 805. Such processing/computing arrangement 805 can be, for example entirely or a part of, or include, but not limited to, a computer/processor 810 that can include, for example one or more microprocessors, and use instructions stored on a computer-accessible medium (e.g., RAM, ROM, hard drive, or other storage device).

As shown in FIG. 8, for example a computer-accessible medium 815 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 815 can contain executable instructions 820 thereon. Storage arrangement 825 may also be provided separately from the computer-accessible medium 815, which can provide the instructions to the processing arrangement 805 so as to configure the processing arrangement to execute certain exemplary procedures, processes, and methods, as described herein above, for example.

Further, the exemplary processing arrangement 805 can be provided with or include input/output ports 835, which can include, for example a wired network, a wireless network, the internet, an intranet, a data collection probe, a sensor, etc. As shown in FIG. 8, the exemplary processing arrangement 805 can be in communication with an exemplary display arrangement 830, which, according to certain exemplary embodiments of the present disclosure, can be a touch-screen configured for inputting information to the processing arrangement in addition to outputting information from the processing arrangement, for example. Further, the exemplary display arrangement 830 and/or a storage arrangement 825 can be used to display and/or store data in a user-accessible format and/or user-readable format.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for implementing an intelligent automatic-pause functionality for recurring electronic transactions, the method comprising:
monitoring electronic transaction activity associated with one or more financial accounts of a user, the electronic transaction activity corresponding to a plurality of electronic transactions comprising one or more card not present (CNP) and one or more card present (CP) transactions;
performing a ratio test on the plurality of electronic transactions, the ratio test comprising computing a ratio of CNP to CP transactions over a predefined time window;
monitoring the computed ratio relative to a threshold value, by repeating the ratio test over a plurality of time windows, wherein a deviation in a value of the computed ratio, consistent with an increase in a relative number of CNP transactions, in excess of the threshold value, indicates a possible closure scenario;
upon detecting the possible closure scenario, initiating a verification of the ratio test based on identifying a corresponding published closure bulletin, the verification comprising:
extracting one or more data values for a first set of characteristic data parameters associated with the corresponding published closure bulletin;
storing the one or more data values corresponding to the first set of data parameters as a first data object in the data store;
upon verifying the ratio test, initiating an identification of one or more invalid transaction strings corresponding to one or more recurring transaction requests from merchants impacted by the corresponding published closure bulletin, the identification comprising:
extracting, from one or more recurring transaction strings, one or more data values corresponding to a second set of data parameters;
storing the one or more data values as a second data object in the data store, wherein the second data object is associated with a uniquely generated transaction identifier for indexing a respective recurring transaction request;
identifying a recurring transaction string as associated with an invalid transaction request based on a match between the first data object and the second data object; and
executing one or more actions for each of one or more invalid recurring transaction strings.

2. The method of claim 1, wherein the first set of characteristics data parameters comprise one or more impacted geographical regions, one or more impacted merchant categories, and a projected timeline associated with a mandated closure scenario and the second set of data parameters, extracted from the one or more recurring transaction strings, corresponds to a merchant service location and merchant type information.

3. The method of claim 1, wherein the one or more actions comprises at least one selected from the group of declining the transaction with a reason code transmitted back to the merchant and notifying the user.

4. The method of claim 3, wherein declining the transaction is preceded by transmitting a notification message to a mobile device associated with the user and requesting a user confirmation prior to declining the transaction.

5. The method of claim 1, further comprising resuming a recurring payment based on the computed ratio dropping below the threshold value.

6. The method of claim 5, wherein the resuming of the recurring payment further comprises transmitting a notification to the user prior to allowing a recurring transaction request, wherein the allowing of the transaction is contingent upon an affirmative response from the user.

7. The method of claim 1, further comprising applying data analytics and machine learning routines to supplement the ratio test in detecting the possible closure scenario.

8. The method of claim 1, wherein the extracting of one or more data values from the corresponding published closure bulletin comprises scraping data using one or more Application Programming Interface (API) calls to one or more third party data repositories.

9. The method of claim 1, wherein the unique transaction identifier associated with the second data object and generated for indexing a recurrent transaction request, corresponds to a virtual credit card number (VN) associated with the recurring transaction request.

10. The method of claim 9, wherein a toggle feature on a decline logic associated with a VN is used to control the recurring transaction request.

11. The method of claim 9, wherein a unique VN is generated for one or more recurring transaction requests, not associated with a VN transaction string, and used as a unique identifier for indexing and controlling the one or more recurring transaction requests not associated with a VN transaction string.

12. The method of claim 1, wherein the indexing of recurring transaction requests comprising of extracting and storing, together with a unique identifier, one or more transaction data values, occurs independently of computing and monitoring of the ratio test.

13. The method of claim 12, wherein the indexing of recurring transaction requests occurs concurrently with the computing and monitoring of the ratio test.

14. The method of claim 1, further comprising identifying one or more incoming transaction strings as being associated with an indexed recurring transaction request, if the one or more incoming transaction strings are identified as having a corresponding unique identifier in the data store, wherein the extracting and storing of one or more transaction data, does not pertain to the one or more incoming transaction strings for which a corresponding unique identifier exists in the data store.

15. The method of claim 14, further comprising flagging a unique identifier, associated with an invalid transaction request, in the data store, and identifying one or more incoming transaction strings as invalid if a flagged unique identifier corresponding to the transaction string is located in the data store.

16. The method of claim 1, wherein the one or more time windows are temporally sequenced in such a way to enable continuous monitoring for detection of a possible shutdown condition.

17. A system for management of electronic transactions with a circumstantial auto-pause functionality, the system comprising:
a computer hardware arrangement configured to:
monitor electronic transaction activity associated with one or more financial accounts of a user, the electronic transaction activity corresponding to a plurality of electronic transactions comprising one or more card not present (CNP) and one or more card present (CP) transactions;
perform a ratio test on the plurality of electronic transactions, the ratio test comprising computing a ratio of CNP to CP transactions over a predefined time window;
monitor the computed ratio relative to a threshold value, by repeating the ratio test over a plurality of time windows, wherein a deviation in a value of the computed ratio, consistent with an increase in a relative number of CNP transactions, in excess of the threshold value, indicates a possible closure scenario;
identify a corresponding published closure bulletin, to verify the ratio test:
extract one or more data values for a first set of characteristic data parameters associated with the corresponding published closure bulletin;
store the one or more data values corresponding to the first set of data parameters as a first data object in the data store;
initiate an identification of one or more invalid transaction strings based on information associated with the corresponding published closure bulletin:
extract, from one or more recurring transaction strings, one or more data values corresponding to a second set of data parameter;
store the one or more data values as a second data object in the data store, wherein the second data object is associated with a uniquely generated transaction identifier to index a respective recurring transaction request;
identify a recurring transaction string as associated with an invalid transaction request based on a match between the first data object and the second data object;
execute one or more actions for each of one or more invalid recurring transaction strings.

18. The system of claim 17, wherein the first set of characteristics data parameters comprise one or more impacted geographical regions, one or more impacted merchant categories, and a projected timeline associated with the corresponding published closure bulletin and the second set of data parameters, extracted from the one or more recurring transaction strings, corresponds to a merchant service location and merchant type information.

19. The system of claim 17, wherein the one more actions comprise at least one selected from the group of declining the transaction with a reason code transmitted back to a corresponding merchant, and a notification message transmitted to a mobile device associated with the user to request a user confirmation prior to declining the transaction notifying the user.

20. A non-transitory computer-readable medium comprising instructions for execution by a processor, wherein, upon execution by the processor, the processor is configured to perform procedures comprising:
monitoring electronic transaction activity associated with one or more financial accounts of a user, the electronic transaction activity corresponding to a plurality of electronic transactions comprising one or more card not present (CNP) and one or more card present (CP) transactions;
performing a ratio test on the plurality of electronic transactions, the ratio test comprising computing a ratio of CNP to CP transactions over a predefined time window;
monitoring the computed ratio relative to a threshold value, by repeating the ratio test over a plurality of time windows, wherein a deviation in a value of the computed ratio, consistent with an increase in a relative number of CNP transactions, in excess of the threshold value, indicates a possible closure scenario;
upon detecting the possible closure scenario, initiating a verification of the ratio test based on identifying a corresponding published closure bulletin, the verification comprising:
extracting one or more data values for a first set of characteristic data parameters associated with the corresponding published closure bulletin;
storing the one or more data values corresponding to the first set of data parameters as a first data object in the data store;
upon verifying the ratio test, initiating an identification of one or more invalid transaction strings corresponding to one or more recurring transaction requests from merchants impacted by the corresponding published closure bulletin, the identification comprising:
extracting, from one or more recurring transaction strings, one or more data values corresponding to a second set of data parameters;
storing the one or more data values as a second data object in the data store, wherein the second data object is associated with a uniquely generated transaction identifier for indexing a respective recurring transaction request;
identifying a recurring transaction string as associated with an invalid transaction request based on a match between the first data object and the second data object;
executing one or more actions for each of one or more invalid recurring transaction strings.
